(19) United States
(12) Patent Application Publication
(10) Pub. No.: US 2015/0047003 A1
(43) Pub. Date: Feb. 12, 2015

(54) VERIFICATION AUTHORITY AND METHOD THEREFOR

(71) Applicant: SAL KHAN, OTTAWA (CA)

(72) Inventor: SAL KHAN, OTTAWA (CA)

(21) Appl. No.: 14/453,901

(22) Filed: Aug. 7, 2014

Related U.S. Application Data
(60) Provisional application No. 61/863,052, filed on Aug. 7, 2013.

(51) Int. Cl. H04L 29/06

(52) U.S. Cl. CPC H04L 63/0884
USPC 726/7

(57) ABSTRACT

A method is disclosed for user verification. From a user system personal data of a first user is provided to a server. From the server the personal data of the first user is provided to an authority server, the personal data for being verified. The personal data of the first user is verified against data stored by the authority server to provide a verification signal indicative of whether the personal data is verified as accurate or other than accurate, the authority server other than a commercial party to a commercial transaction between the first user and the server; and when the personal data of the first user corresponds with data stored by the authority server. Then the verification signal indicating that the personal data is accurate personal data of the first user is provided to the server.

### FIELD OF THE INVENTION

This invention relates to personal identity management and verification and more particularly to a method and system of providing an authority for personal identity verification and identity attribute issuance.

### BACKGROUND OF THE INVENTION

Digital identity is the data that uniquely describes a person or a thing and contains information about the subject's relationships within the digital world, commonly referred to as cyberspace, World Wide Web (WWW) or Internet. A critical problem is knowing the true identity with whom one is interacting either within electronic messaging, Internet accessible content, or transaction. Currently there are no ways to precisely determine the identity of a person in digital space. Even though there are identity attributes associated to a person's digital identity, these attributes or even identities can be changed, masked or dumped and new ones created. Despite the fact that there are many authentication systems and digital identifiers that try to address these problems, there is still a need for a unified and verified identification system. Further, there are still the needs for respecting the privacy of individuals, maintaining security of the elements of a digital identity and associating.

Within the prior art in order to assign a digital representation to an entity, the attributing party must trust that the claim of an attribute is correct and associated with the person or thing presenting the attribute. Conversely, the individual claiming an attribute may only grant selective access to its information. Accordingly, authentication is a key aspect of trust-based identity attribution, providing a codified assurance of the identity of one entity to another. Within the prior art authentication methodologies include the presentation of a unique object such as a bank credit card, the provision of confidential information such as a password or the answer to a pre-arranged question, the confirmation of ownership of an e-mail address, and more robust but relatively costly solutions utilising encryption methodologies. However, such methodologies can be circumvented by an individual or enterprise as the high levels of online electronic fraud attest as well as efforts expended to provide anti-money laundering and counter-terrorism funding solutions globally.

Whilst technological progress in authentication continues to evolve, these systems do not prevent aliases being used and hence a unique association of a digital identity with a physical identity. Accordingly, the inventors address these issues through the provisioning of an authority for personal identity verification.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to real world and virtual world identities and more particularly to authenticating users within the virtual world based upon credentials issued in response to validated and authenticated real world identities.

In accordance with an aspect of the invention there is provided a method comprising:
providing from a user system to a server personal data of a first user;
providing from the server to an authority server the personal data of the first user, the personal data for being verified;
verifying the personal data of the first user against data stored by the authority server to provide a verification signal indicative of whether the personal data is verified as accurate or other than accurate, the authority server other than a commercial party to a commercial transaction between the first user and the server; and
when the personal data of the first user corresponds with data stored by the authority server, providing the verification signal indicating that the personal data is accurate personal data of the first user to the server.

In accordance with an aspect of the invention there is provided a method comprising:
initiating a session between a first user system and a server;
communicating personal data from a secure personal data store of the first user system to the server; communicating from the server to an authority server a request for verification of the personal data;
verifying by the authority server the personal data; when the personal data is other than accurate, providing a first signal indicative of the first data being other than accurate; and
when the personal data is accurate, providing a first signal indicative of the first data being authorized.

In accordance with an aspect of the invention there is provided a method comprising:
providing an authority server for verifying personal data of each of a plurality of users;
providing verification data to the authority server for use in verification, the verification data other than the personal data and provided with an indication of a security of the provided data; and
storing within a database the verification data and the data associated with a security of the data for use in authenticating personal data of each of the plurality of users.

In accordance with an aspect of the invention there is provided a method comprising:
storing personal data within a secure personal data store of a first user system;
establishing a secure connection with a server, the secure connection between the server and the first user system;
transmitting from the first user system to the server, personal data from the secure personal data store of the first user system;
verifying the personal data received at the server by: transmitting a request for personal data verification to an authority server; and receiving from the authority server a verification signal indicative of the data being verified when data relating to the personal data matches expected values within the authority server, the authority server other than a commercial party forming part of commerce relating to the transaction.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1 and 2 depict a first portion of a real world and virtual world identity ecosystem according to an embodiment of the invention;

FIG. 3 is a simplified block diagram of a secure USB storage device for storing personal information according to an embodiment of the invention;

FIG. 4 is a simplified flow diagram of a method of making a purchase on a commercial website

FIG. 5 is a simplified diagram of an information exchange website acquiring personal data;

FIG. 6 is a simplified block diagram of information a commercial website acquiring personal data relating to a financial instrument;

FIG. 7 is a simplified flow diagram of a method of verifying data or identification of a user according to an embodiment of the invention;

FIG. 8 is another simplified flow diagram of a method of verifying data or identification of a user according to an embodiment of the invention;

FIG. 9 is yet another simplified flow diagram of a method of verifying data or identification of a user according to an embodiment of the invention;

FIG. 10 is yet another simplified flow diagram of a method of verifying data or identification of a user according to an embodiment of the invention;

FIG. 11 is yet another simplified flow diagram of a method of verifying data or identification of a user according to an embodiment of the invention;

FIG. 12 depicts a network environment within which embodiments of the invention may be employed;

FIG. 13 depicts a wireless portable electronic device supporting communications to a network such as depicted in FIG. 12 and as supporting embodiments of the invention

### DETAILED DESCRIPTION

The present invention is directed to real world and virtual world identities and more particularly to authenticating users within the virtual world based upon credentials issued in response to validated and authenticated real world identities.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, client, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” or “credential holder” as used herein refers to an individual who, either locally or remotely, by their engagement with a service provider, third party provider, enterprise, social network, social media etc. via a dashboard, web service, website, software plug-in, software application, or graphical user interface provides an electronic credential as part of their authentication with the service provider, third party provider, enterprise, social network, social media etc. This includes, but is not limited to, private individuals, employees of organizations and/or enterprises, members of community organizations, members of charity organizations, men, women, children, and teenagers. “User information” as used herein may refer to, but is not limited to, user identification information, user profile information, and user knowledge.

A “security credential” (also referred to as a credential) as used herein may refer to, but is not limited to, a piece of evidence that a communicating party possesses that can be used to create or obtain a security token. This includes, but is not limited to, a machine-readable cryptographic key, a machine-readable password, a cryptographic credential issued by a trusted third party, or another item of electronic content having an unambiguous association with a specific, real individual. Such security credentials may include those that are permanent, designed to expire after a certain period, designed to expire after a predetermined condition is met, or designed to expire after a single use.

A “government issued photographic identity document” as used herein may refer to, but is not limited to, any document, card, or electronic content item issued by a government body for the purposes of identifying the owner of the government issued photographic identity document. Such government bodies may, for example, be provincial, federal, state, national, and regional governments alone or in combination. Such government issued photographic identity documents, also referred to within this specification as Photo-ID cards, government issued photographic cards, and government issued identity documents may include, but are not limited to, a driver's license, a passport, a health card, national identity card, and an immigration card although they have the common feature of a photographic image, multimedia image, or audiovisual image of the user to whom the government issued photographic identity document was issued. Such government issued photographic identity documents may include, but not be limited to, those comprising single sided plastic card, double sided plastic cards, single sided sheets, double side sheets, predetermined sheets within a book or booklet, and digital representations thereof in isolation or in combination with additional electronic/digital data that has been encoded/encrypted. For example, a digital memory with fingerprint scanner in the form of what is known as a “memory stick” may be securely issued by a government body as the fingerprint data for the user is securely encoded and uploaded together with image and digital content data. Subsequently, the digital memory when connected to a terminal and activated by the user's fingerprint may transfer the required digital data to the terminal to allow for a verification that the user is the one and the same. Such memory devices can be provided which destroy or corrupt the data stored within upon detection of tampering.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as those for example listed on Wikipedia (see http://en.wikipedia.org/wiki/List_of_file_formats). Within a broader approach digital content may include any type of digital information that is at least one of generated, selected, created, modified, and transmitted in response to a request, wherein said request may be a query, a search, a trigger, an alarm, and a message for example.

“Encryption” as used herein may refer to, but are not limited to, the processes of encoding messages or information in such a way that only authorized parties can read it. This includes, but is not limited to, symmetric key encryption through algorithms such as Twofish, Serpent, AES (Rijndael), Blowfish, CASTS, RC4, 3DES, and IDEA for example, and public-key encryption through algorithms such as Diffie-Hellman, Digital Signature Standard, Digital Signature Algorithm, ElGamal, elliptic-curve techniques, password-authenticated key agreement techniques, Paillier cryptosystem, RSA encryption algorithm, Cramer-Shoup cryptosystem, and YAK authenticated key agreement protocol.

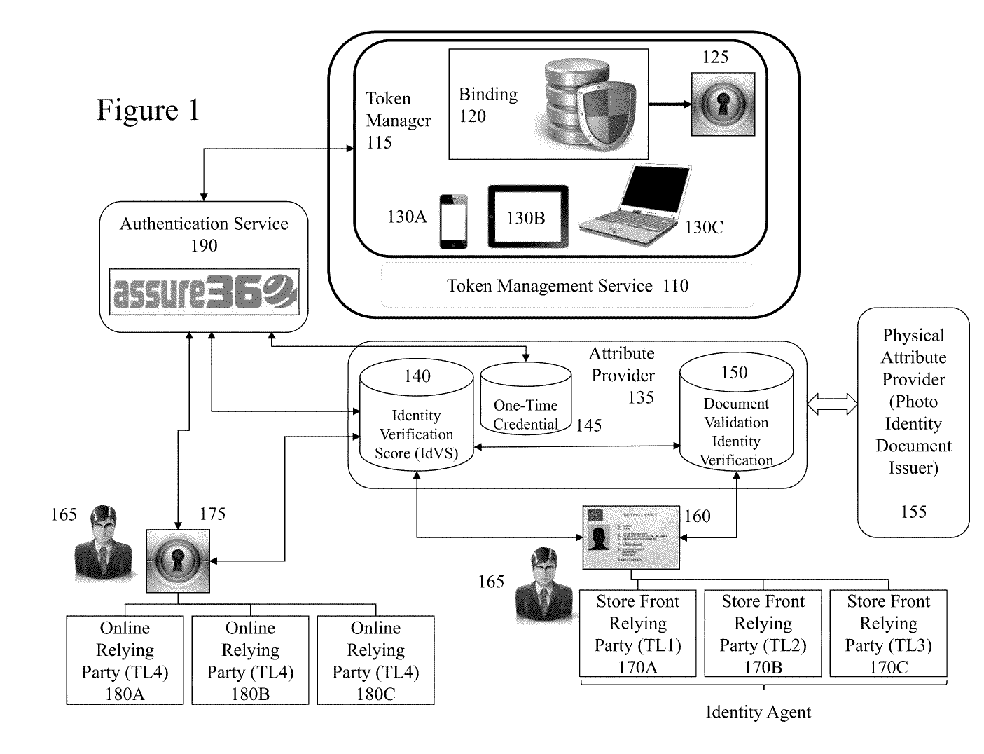

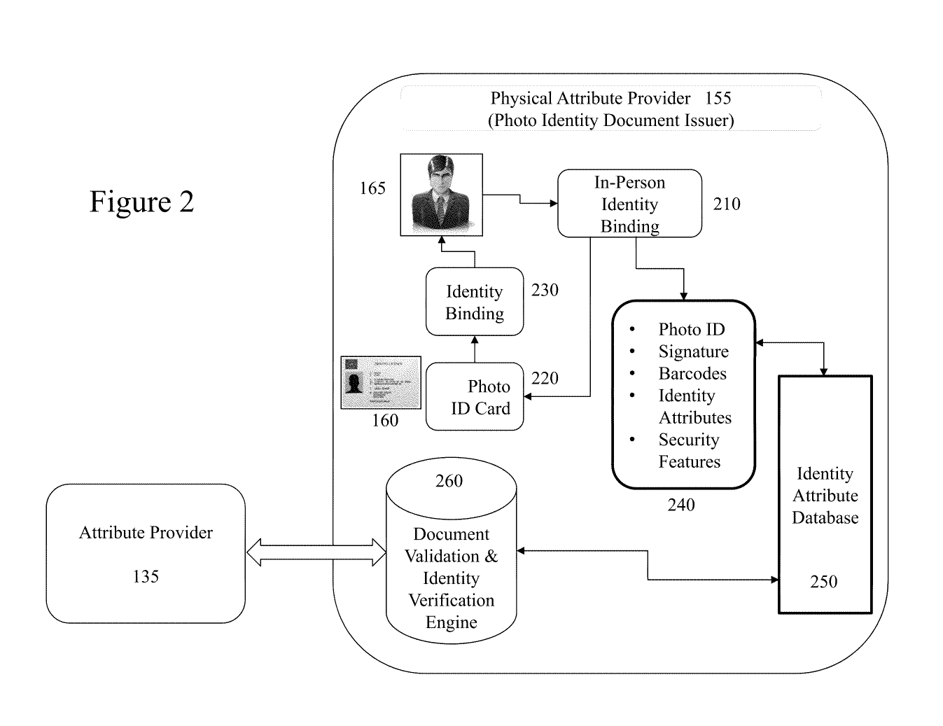

Referring to FIGS. 1 and 2 there are depicted first and second portions of a real and virtual world identity ecosystem (RVWIE) according to an embodiment of the invention. As depicted in FIG. 1 this RVWIE comprises a physical attribute provider (PHYSAP) 155 in communication with an attribute provider 135. The PHYSAP 155 being depicted schematic as process flow detail in FIG. 2. The PHYSAP 155 represents an identity document issuer wherein the identity document includes a photograph of the user 165 to whom it relates. Accordingly, the PHYSAP 155 is a government issuing authority or an authority licensed by a government to issue identity documents. The government authority may be national, provincial, federal, or state for example. Such identity documents may include, but are not limited to, a driver's license, a passport, a health card, national identity card, and an immigration card.

Accordingly, a credential holder (user 165) is identity-proofed in-person by a trusted agent of the government photographic identity issuing authority, PHYSAP 155. This process step 210 results in the issuance of Photo-ID card 160 (step 220) and the credential holder's proofed identity being bound (step 230) to the government photographic identity document. As a result of this sequence the credential holder's identity-proofed attributes being stored in step 240 within a government Identity Attribute Database 250 managed by the document issuer. Attributes stored in respect of the credential holder within the Identity Attribute Database 250 may include, but not be limited to, the photograph of the user 165, the signature of the user 165, the user's name and address, type of document, and date of issue. The information within the Identity Attribute Database 250 is also accessible by a Document Validation and Identity Verification Engine (DVIVE) 260 which is in communication with an Attribute Provider 135.

Subsequently, the user 165 (credential holder) uses their Photo-ID card 160 at a storefront retailer/government office or kiosk/enterprise, depicted as first to third store front relying parties 170A to 170C respectively, to identify themselves in the presence of an agent of the store front relying party. The first to third store front relying parties 170A to 170C each exploit a Photo-ID checker, referred to within this specification as a Ping 360 system/device. According to the identity of the first to third store front relying parties 170A to 170C respectively these are allocated different trust levels. For example:

Trust Level 1 (TL1)—government office, civic authority, e.g. another government Photo-ID issuing authority or government/civic office where the credential holder's identity is proofed, having higher trust level than other relying parties.

Trust Level 2 (TL2)—financial institutions, e.g. a bank, having a higher trust level than other relying parties, such as retailers, etc. but not at a level not as high as relying parties at a Trust Level 1.

Trust Level 3 (TL3)—all other identity agents, not included in the above trust levels 1 and 2 respectively.

An additional trust level, Trust Level 4 (TL4), is associated with online merchants as indicated in FIG. 1 with first to third online relying parties 180A to 180C respectively. This trust level, TL4, may also be associated with online activities with a government, government regulated body, online enterprise etc. Whilst embodiments of the invention are described as having four trust levels (TL1 to TL4 respectively) it would be evident that within alternate embodiments a higher or lesser number of trust levels may be employed. However, for each trust level the activities of a user are tracked and stored within the databases as described with respect to embodiments of the invention and employed as described below in generating an Identity Verification Score for the user with the government issued photographic identity document.

Whilst embodiments of the invention are described as having four trust levels (TL1 to TL4 respectively) it would be evident that within alternate embodiments a higher or lesser number of trust levels may be employed. The Ping 360 system, located at the store front relying party's place of business and not shown for clarity, interacts with the Attribute Provider 135 to validate the Photo-ID card 160 and verify the identity of the document bearer, user 165. Accordingly, the Ping 360 system acquires data from and about the Photo-ID card 160 and communicates this to a Document Validation Identity Verification database (DVIVDb) 150 which then communicates with the DVIVE 260 within the PHYSAP 155. The DVIVE 260 thereby confirms or denies the validity of the Photo-ID card 160 presented by the user 165 at the one of the first to third store front relying parties 170A to 170C respectively. The DVIVE 260 extracts data from the Identity Attribute Database 250 as part of the validation activity.

Accordingly, the Ping 360 system validates the Photo-ID card 160 as being genuine or counterfeit. As described supra the Ping 360 system extracts characteristic information from the Photo-ID card 160 which is transmitted to the DVIVDb 150 managed and controlled by Attribute Provider 135. The extracted characteristics are then provided to DVIVE 260 wherein they are compared with data extracted from Identity Attribute Database 250 and a resulting validation/denouncement of the Photo-ID card 160 is communicated back to the DVIVDb 150 and therein back to the Ping 360 for presentation to the agent of the store front relying party. Extracted characteristics may include, but are not limited to, the photograph on the Photo-ID card 160, a signature, identity information of the Photo-ID card 160, barcode data, QR code data, data within magnetic stripe(s), etc. as well as potentially characteristics of the card itself.

The data within the Identity Attribute Database 250 maintained and acquired/generated by the PHYSAP 155 relating to the Photo-ID card 160 when the user 165 applied for, or renewed, their Photo-ID card 160. Accordingly, the user 160 during the course of doing business at various retail service provider's locations, the credential holder's (user 165) Photo-ID card 160 is validated and their identity verified by Attribute Provider's 135 DVIVDb 150. Therefore, each time the user's 165 Photo-ID card 160 (or Photo-ID document) is validated and the bearer's identity is verified by the combination the Ping 360 system, DVIVDb 150, and DVIVE 260 as being genuine and not fake, then the credential holder's in-person verified identity is also confirmed as being genuine. As depicted and described below in respect of FIG. 8 the Attribute Provider 135 also generates one or more Identity Verification Scores (IdVS) which are subsequently stored within an Identity Verification Score database 140. As a result, Ping 360 software is able to generate a quantified measure of the credential holder's identity and inform participating businesses, employers, and organizations of the strength of the credential holder's identity.

An Identity Verification Score (IdVS) may be considered to be similar to a FICO score, which is used by financial institutions to help them make complex, high-volume decisions and grant credit to a user. As described in more detail below, and as established supra, in order to create a representative IdVS for each credential holder (user 165), where their Photo-ID card 160 is verified by a Ping 360 system, a trust level (TL) for each storefront relying party (Identity Agent) is established as outlined supra in dependence upon the storefront retailing party class, e.g. financial institutions have higher trust level than a retailer but not as high as a government office or civic authority office. In addition to trust level an IdVS computation according to embodiments of the invention may take into account the number of times the credential holder's photo-ID document is validated and the credential holder's identity verified.

As depicted in FIG. 1 IdVS data is also available for use by online relying parties, such as first to third online relying parties 180A to 180C respectively who may also act as identity agents for Attribute Provider 135. It is also available for use by online authentication services, such as for example, Authentication Service 190 depicted as Assure 360 Identity Assurance Service. The user 165, upon being verified through PHYSAP 155, may establish an account with an Attribute Provider 135 by forwarding an electronic mail address through an Identity Agent, depicted within FIG. 1 by first to third store front relying parties 170A to 170C respectively, via a Ping 360 display, e.g. a tablet electronic device. The user 165 may have the ability to choose an Attribute Provider 135 from multiple Attribute Providers 135 as part of the process performed through an Identity Agent where they provide their electronic mail address. Optionally, the ability of a user 165 to communicate with and/or open an account with an Attribute Provider 135 may be restricted to a store front relying party at only one or more trust levels, e.g. those with trust level 1 (TL1) only for example. Additionally, the user 165 may be prevented from accessing an Identity Agent to establish the account with an Attribute Provider 135 until at least one or a predetermined number of activities have been completed with the store front relying parties at the appropriate trust levels. Further, the Identity Agent may only be accessed by the user 165 upon an authentication of their identity at the store front relying party by an action of an agent of the store front relying party.

The user 160 may then select an Authentication Service 190 from those provided by the Attribute Provider 135 web site of the Attribute Provider 135 the user 165 has selected. The Attribute Provider 135 sends a one-time-credential retrieved from One-Time Credential database 145 to the selected Authentication Service 190 and a credential 175 to the credential holder (user 160). Attribute Provider 135 also sends the Authentication Service 190 information required by the Authentication Service 190 to open an online account in the credential holder's name. Optionally, the user 165 may be presented with separate lists of Attribute Providers 135 and Authentication Services 190 during their establishment of the account or subsequently the user 165 may access any Authentication Service 190 rather than only a subset of them associated with the selected Attribute Provider 135. The credential holder can use the one-time credential sent by Attribute Provider 135 to identify themselves to the selected Authentication Service 190 to confirm the online account which was opened automatically on the credential holder's behalf by the Authentication Service 190 when the Authentication Service 190 received the one-time-credential and the credential holder's information necessary to open an account. Once the account with the Authentication Service 190 is active the credential holder can link their PED and/or FED to the Authentication Service 190's server by downloading the Authentication Service 190's client and related digital security certificates onto their PED and/or FED. A security certificate exchange takes place between the Authentication Service 190 and the Token Management Service 110, which may for example be upon a server associated with the Authentication Service 190 or may be upon a server associated with a third party. Accordingly, the Token Management Service 110 comprises a Token Manager 115 that binds, denoted by Binding 120, the digital security certificates 125 to the user's 160 PEDs/FEDs such as depicted by first to third devices 130A to 130C respectively.

As a result the credential holder's identity is bound to the credential holder's PEDs and/or FEDs and to the Authentication Service 190/Token Management Service 110 thereby providing to one of the first to third online relying parties 180A to 180C respectively with strong authentication and Level 3, in-person, verified identity assurance. Based on the credential holder's IdVS, which is obtained from Identity Verification Score database 140 the Attribute Provider 135 can provide Authentication Service 190, and other authentication services, with revocation status information on the credential holder. Accordingly, the Authentication Service 190 may revoke, cancel, or not authenticate the security credential 175 of the user 165. It would be evident that in some embodiments of the invention the Authentication Service 190 does not retain or store the one-time credentials 175.

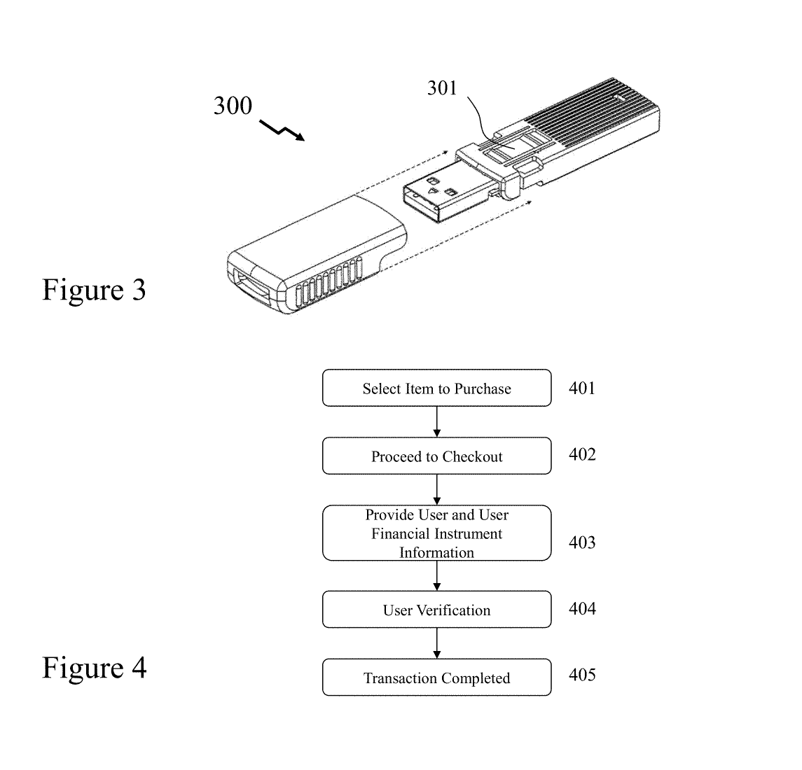

Referring to FIG. 3, shown is a secure USB storage device 300 for storing personal information. The personal identity storage device, namely secure USB storage device 300, is secured in reliance upon biometric information of the individual to whom it is associated. Typically, this is in the form of a fingerprint captured with fingerprint imager 301. Within the secure USB storage device 300 is a security circuit for maintaining data therein in a secure form and for releasing the data only upon secure authentication via the biometric authentication alone or through biometric authentication in conjunction with one or more other techniques such as additional biometric authentication, password verification, etc. upon a PED or FED to which the secure USB.storage device 300 is connected.

There are two well-known implementations of the secure USB storage device 300. In a first implementation, the device only communicates with known approved systems. A, the device is secure and only communicates with an approved destination device or devices in order to maintain security of data stored therein in the form of passwords and user identifying data. In a second implementation, the device releases data stored therein in response to authentication thereto. In this second implementation the data store is secure, but the data stored therein is released via unsecure channels and may be intercepted once outside the device. In order to address some of the issues with secure personal information storage, secure storage has recently been offered within data processors in order to maintain the data and its use within a secure closed environment. Unfortunately, even in these instances, it is often necessary to communicate personal information outside of the secure closed environment.

Now referring to FIG. 4 shown is a simplified method of making a purchase on a commercial web site, such as one of online relying parties 180A to 180C respectively in FIG. 1 or another website associated with an enterprise, a service provider or a third party provider for example. At step 401 a user selects items to be purchased and proceeds to “checkout” at step 402 within the commercial web site, e.g. one provided by a retailer, enterprise, service provider, etc. The user then provides their name, address, billing address, credit card number, and other credit card information at step 403. Once verified at step 404, the transaction is processed and completed at step 405. Between the user system and the web site, a secure connection is formed. The secure connection is for preventing unauthorized interception of the user data by a third party. The credit card and billing information is verified by the commercial website relying on the bank for verification. Thus, the data is verified by the party that will pay the bill prior to the completion of the transaction. Of course, if a wallet is stolen, all the data needed to enter and complete such a transaction is immediately available including the address, credit card information, name, etc. of the owner of the stolen wallet. Thus, stealing identities is possible through physical theft. Further, if a web site security is inadequate, it is possible to intercept the “secure” communication and to decipher the information therein thereby allowing for digital identity theft as well.

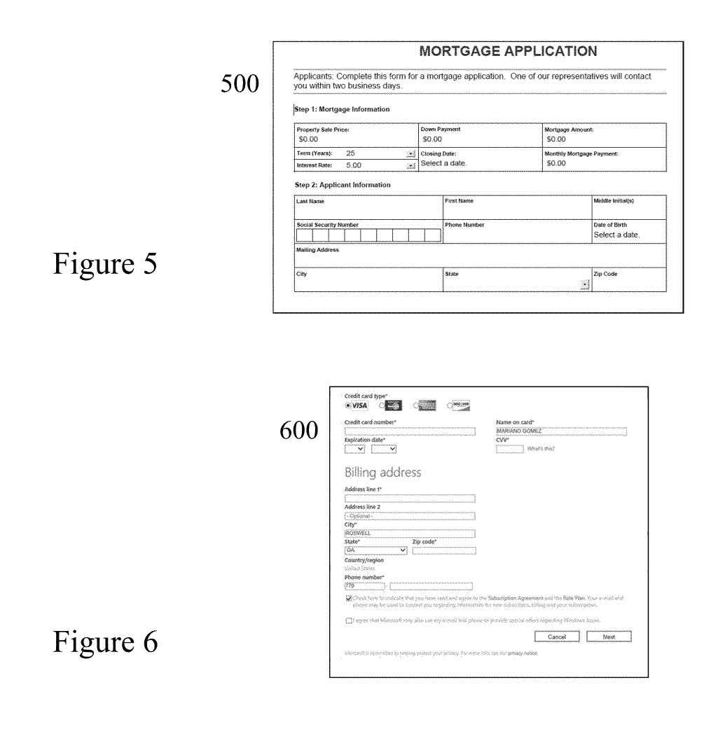

Referring to FIG. 5, shown is another information exchange website 500 acquiring personal data, such as one of online relying parties 180A to 180C respectively in FIG. 1 or another website associated with an enterprise, a service provider or a third party provider for example. Here, the website is collecting information other than financial data. For example, if a Social Security Number (SSN) is required, the site requests this. Unfortunately, the site cannot verify the social security number, and instead hashes it to verify that it is a possible social security number. The hashes for such personal data are well known and could just as easily be used by a perpetrator as by a legitimate agency. As long as the data represents a potentially correct value, then it is either hashed correctly or the hash itself is correct and in either instance it is accepted, though there is no way to know that the SSN provided actually belongs to the person to whom it is claimed to belong to nor that the SSN and/or personal data provided belong to this person providing it.

Referring to FIG. 6 shown is the information 600 a commercial website acquiring personal data relating to a financial instrument actually requires, such as one of online relying parties 180A to 180C respectively in FIG. 1 or another website associated with an enterprise, a service provider or a third party provider for example. Here the commercial website needs information leading to a payment. It does not need to know the purchaser nor the purchaser's information. The vendor is concerned with payment. In some cases, the address for shipping is also needed, but even then, sometimes another party will ship and it is enough to know that an address is provided to them. Thus, many parties are collecting data merely for completeness, for their records, or because they need the information in order to ensure that a transaction is completed.

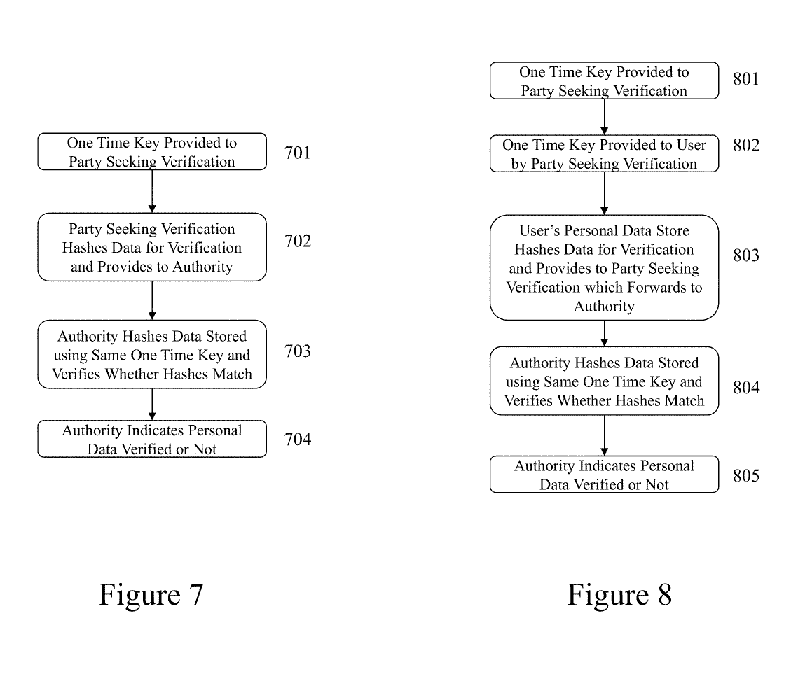

Referring to FIG. 7, shown is a method of verifying data or identification of a user according to an embodiment of the invention. Here, an authority is established for verifying personal data wherein the authority manages the authorization and verification process for the personal data. The authority may, according to embodiments of the invention be one or more of the Attribute Provider 135, PYSAP 155, and Authentication Service 190. The authority stores personal data of the user which it then uses for verification against personal data purporting to refer the same individual that is being verified. When a user provides data from their personal data store, e.g. secure USB storage device 300, to a third party, the data is verifiable against the authority. Accordingly, as depicted in FIG. 7, a one-time key is provided to the party seeking verification at step 701. The party seeking verification then hashes the data for verification with the one time key and provides it to the authority at step 702. At step 703, the authority hashes the data stored therein using the same key and verifies that the hashes match. In response to a match between the hash values, the authority indicates that the personal data is verified at step 704 otherwise it indicates a verification failure.

When the authority is trusted, such a system provides data verification not only for personal data per se but also for combinations of personal data. For example, does is this social security number belong to the same individual as the provided name and that birth date. Further, because the authority is trusted, verification by the authority supports the transaction.

Referring to FIG. 8, shown is another method of verifying data associated with a user or verifying an identification of a user. Here, an authority is established for verifying personal data wherein the authority manages the authorization and verification processes for the data as well as storing personal data of the user. The authority may, according to embodiments of the invention be one or more of Attribute Provider 135, PYSAP 155, and Authentication Service 190. The personal data is stored to be verified against separately provided personal data that is being verified as part of an activity relating to the user to whom the personal data relates. When a user provides data from their personal data store to a third party, the data is verifiable against the authority. In the flow diagram depicted in FIG. 8, a one-time key is provided to the party seeking verification at step 801, which is then provided to the user at step 802. The user's personal data store then hashes the user's personal data for verification using this one time key and provides it to the party seeking verification who then provides this to the authority at step 803. At step 804 the authority hashes the personal data stored therein using the same key and verifies that the hashes match. In response to a match between the hash values, the authority indicates that the personal data is verified at step 805. Optionally, one of the authority and the personal data store provides a subset of the personal data to the third party as needed.

When the authority is trusted, such a system provides data verification not only for personal data but also for different combinations of personal data. Further, because the authority is trusted then verification by the authority supports the transaction. Finally, the third party need not receive any of the information necessary for data verification, i.e. the user's personal data, but it does have access to the information necessary for completing the transaction.

In some embodiments of the invention the personal data is distributed by at least one of the authority and the personal data store to each party for completing the transaction.

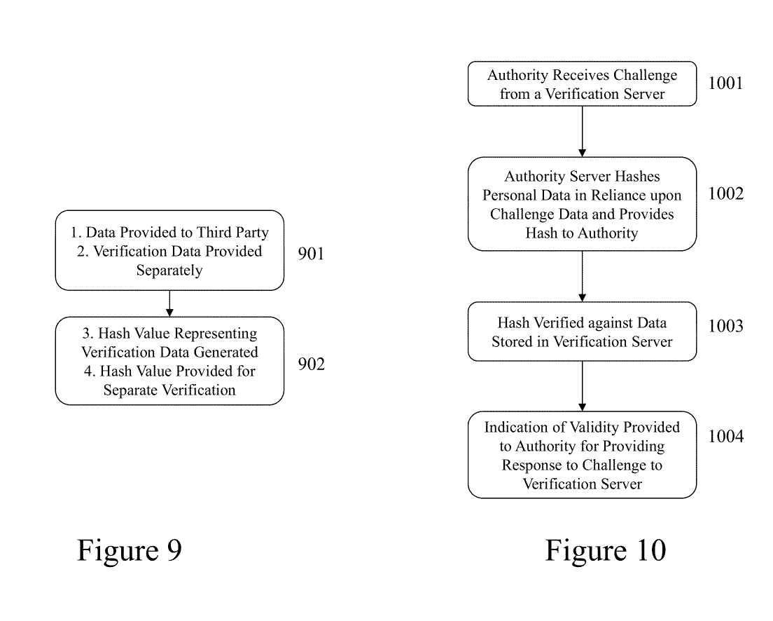

Now Referring to FIG. 9 there is depicted a method of verifying data or identification of a user according to an embodiment of the invention. Here, an authority is established for verifying personal data and the authority manages the authorization and verification process for the data. The authority may, according to embodiments of the invention be one or more of Attribute Provider 135, PYSAP 155, and Authentication Service 190. The authority stores hashes of personal data of each user. These hashes are stored for subsequent verification against personal data that is being verified. When a user provides data from their personal data store to a third party, the data is verifiable against the authority by hashing the data and comparing it to the data within the authority. Alternatively, the data is provided to the authority which hashes said data and compares it. Further alternatively, the hashed data is stored within the personal data store for use in verification. In the flow diagram shown in FIG. 9, data is provided to the third party separate from the verification data at step 901 allowing a hash value representing the verification data to be provided for separate verification at step 902. The hash value is optionally provided via a different communication path. In this fashion, the authority need not store nor have access to the actual personal data of the user, thus maintaining user privacy and security. Conversely, by providing a numerical value for use in performing the hash, the authority can provide additional security to the server which will know it has acted on the correct personal data in forming the hash. Further optionally, the authority stores multiple different hashes for each personal data allowing for challenge response to servers seeking authorization.

When the authority is trusted, such a system provides data verification not only for personal data but also for combinations of personal data. Further, because the authority is trusted, verification by the authority supports the transaction. Finally, the third party need not receive any of the information necessary for data verification such as the social security number but has access to the information necessary for completing the transaction.

Referring to FIG. 10 there is depicted another method of verifying data or identification of a user. Here, an authority is established for verifying personal data and managing the authorization and verification process for the data. The authority may, according to embodiments of the invention be one or more of Attribute Provider 135, PYSAP 155, and Authentication Service 190. The authority stores data relating to a verification server for verifying each piece of personal data. For example, a passport number is verified by the passport authority and a social security number by the social security office. Those verification servers have access to the personal data as typically they are the issuer of the personal data. That said, the authority does not have access to the personal data.

Accordingly, a server seeking to verify personal data, e.g. one associated with Authentication Service 190, Attribute Provider 135, first to third online relying party 180A to 180C respectively, first to third store front relying party 170A to 170C respectively, provides the personal data or data derived from the personal data to the authority for verification. For example, where the server seeking verification is associated with Attribute Provider 135 then the authority would be the PHYSAP 155 but if associated with one of first to third online relying party 180A to 180C respectively then the authority could be one or more of Attribute Provider 135, PYSAP 155, and Authentication Service 190. For example, at step 1001, the authority receives from a verification server a challenge and provides same to the server for use in hashing the personal data. The server hashes the personal data in reliance upon the challenge data and provides the hash to the authority at step 1002. The hash does not allow the authority access to the personal data. At step 1003, the hash is then verified against the personal data stored in the verification server to provide an indication of whether the data is valid. The indication is provided to the authority for use in providing a response to the server indicating whether the data is correct or not at step 1004.

Since for each piece of data a different verification server is supported, data from a variety of distinct and/or different sources can be verified. For example, this data may include an employee number, a credit card number, passport number, driving license serial number, credit card numbers, passport numbers, etc. Further, verification of a set of values would require several verification sources to verify the data independently. Also, verification server output values are prioritisable in terms of value such that data from some verification servers is more reliable than others. Being verified by a Government organization, e.g. driver license bureau, passport office, etc., may be considered more secure than an employer provided identity or an identity from a service provider/enterprise, e.g. CostCo™. Similarly, verification of an individual's military identity would generally be considered more reliable than verification of a taxi license and so forth.

Advantageously, a similar process is implementable without providing the personal data to the server. For example, the challenge is forwarded by the server to the secure personal data store which replies to the challenge via the authority; in such a case, the authority does not access the data within the personal data store, but verifies the challenge response and/or the communication path between server and personal data store.

As with the other embodiments of the invention when the authority is trusted, such a system provides data verification not only for personal data but also for combinations of personal data such as is this social security number associated with that name and that birth date. Further, because the authority is trusted, verification by the authority supports the transaction. Finally, the third party need not receive any of the information necessary for data verification such as the social security number but has access to the information necessary for completing the transaction. In some embodiments, personal data is distributed by at least one of the authority and the personal data store to each party for completing the transaction.

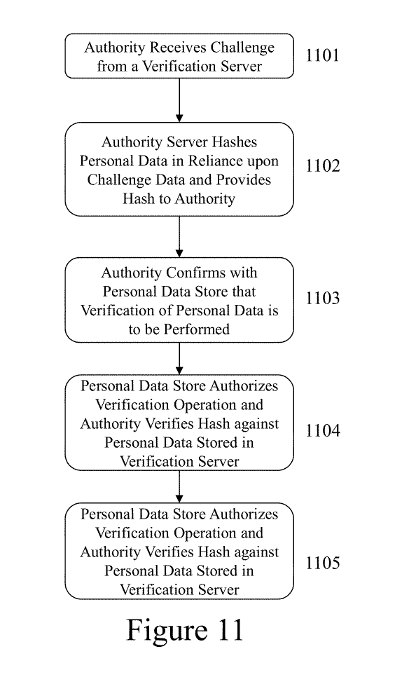

Referring to FIG. 11 there is depicted a method of verifying data or identification of a user according to an embodiment of the invention. Here, an authority is established for verifying personal data and managing the authorization and verification process for the data. The authority may, according to embodiments of the invention be one or more of Attribute Provider 135, PYSAP 155, and Authentication Service 190. The authority stores data relating to a verification server for verifying each piece of personal data. For example, a passport number is verified by the passport authority and a social security number by the social security office. Those verification servers have access to the personal data as typically they are the issuer of the personal data. That said, the authority does not have access to the personal data. Accordingly, a server seeking to verify personal data, e.g. one associated with Authentication Service 190, Attribute Provider 135, first to third online relying party 180A to 180C respectively, first to third store front relying party 170A to 170C respectively, provides the personal data or data derived from the personal data to the authority for verification. For example, where the server seeking verification is associated with Attribute Provider 135 then the authority would be the PHYSAP 155 but if associated with one of first to third online relying party 180A to 180C respectively then the authority could be one or more of Attribute Provider 135, PYSAP 155, and Authentication Service 190.

For example, the authority receives from a verification server a challenge at step 1101 and provides same to the server for use in hashing the personal data at step 1102. The server hashes the personal data in reliance upon the challenge data and provides the hash to the authority at step 1103. The hash does not allow the authority access to the personal data. The authority then confirms with a personal data store of the first user that verification of the personal data is to be performed at step 1104. When the personal data store authorizes the verification operation, the authority verifies the hash against the personal data stored in the verification server to provide an indication of whether the data is valid at step 1105. The indication is provided to the authority for use in providing a response to the server indicating whether the data is correct or not at step 1105.

Since the personal data store authorizes verification operations, the personal data store also acts as a gate to certain transactions making identity theft or impersonation more difficult. Unless the personal identity store has provided the information to the server that is presently seeking verification, the personal data store is unlikely to authorize the authority to verify said data. Thus, an added protection against copying and providing information to a server is provided.

In some embodiments, personal data is distributed by at least one of the authority and the personal data store to each party for completing the transaction.

By centralizing the authority a reliable and ubiquitous data verification service is supported for verifying user identification and personal data sets. When the authority relies on secure mechanisms for user verification such as in person detailed verification, the authority's responses are reliable and with the reliability of the authorization, freedom of the server to interact with or supply wares or services to the first user improves.

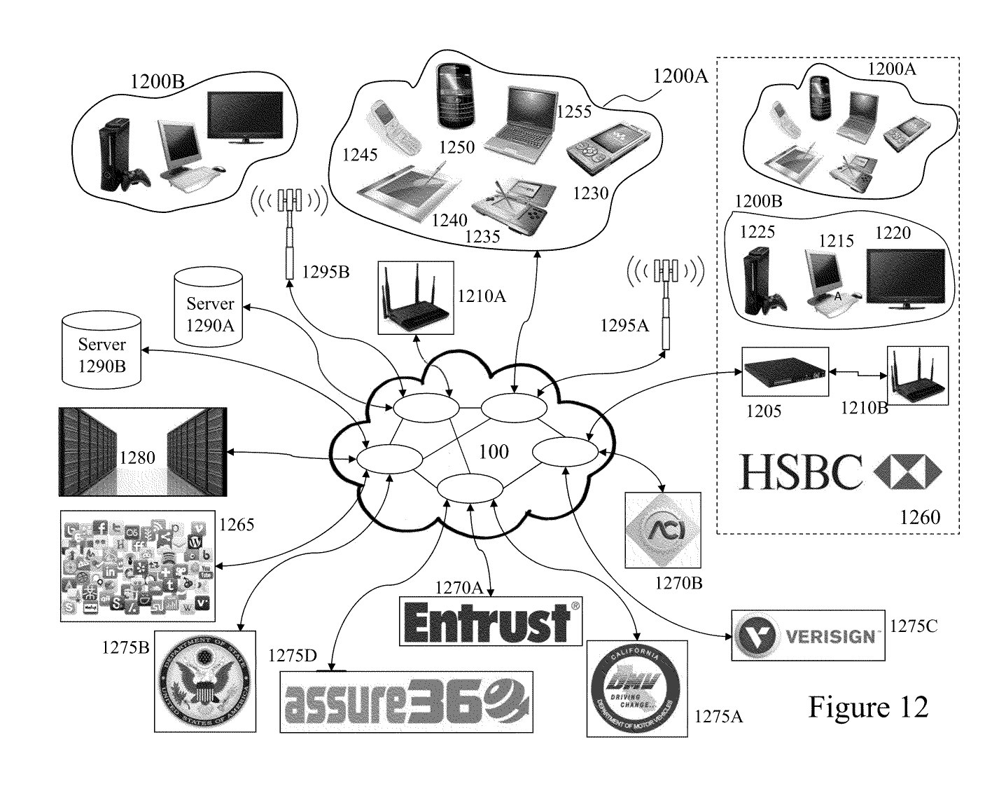

Referring to FIG. 12 there is depicted a network 100 within which embodiments of the invention may be employed supporting real world and virtual world identity ecosystems (RVWIEs) according to embodiments of the invention. Such RVWIEs, for example supporting activities such as the establishment of real world identity assurance, Level 3 assurance to physical store front relying enterprises, the binding of real world identity to electronic devices, and the provisioning of Level 3 identity verification to online retail relying enterprises. As shown first and second user groups 1200A and 1200B respectively interface to a telecommunications network 100. Within the representative telecommunication architecture a remote central exchange 1280 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 1280 is connected via the network 100 to local, regional, and international exchanges (not shown for clarity) and therein through network 100 to first and second cellular APs 1295A and 1295B respectively which provide Wi-Fi cells for first and second user groups 1200A and 1200B respectively. Also connected to the network 100 are first and second Wi-Fi nodes 1210A and 1210B, the latter of which being coupled to network 100 via router 1205. Second Wi-Fi node 1210B is associated with Enterprise 1260, e.g. HSBC™, within which other first and second user groups 1200A are and 1200B. Second user group 1200B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 1205.

Within the cell associated with first AP 1210A the first group of users 1200A may employ a variety of PEDs including for example, laptop computer 1255, portable gaming console 1235, tablet computer 1240, smartphone 1250, cellular telephone 1245 as well as portable multimedia player 1230. Within the cell associated with second AP 1210B are the second group of users 1200B which may employ a variety of FEDs including for example gaming console 1225, personal computer 1215 and wireless/Internet enabled television 1220 as well as cable modem 1205. First and second cellular APs 1295A and 1295B respectively provide, for example, cellular GSM (Global System for Mobile Communications) telephony services as well as 3G and 4G evolved services with enhanced data transport support. Second cellular AP 1295B provides coverage in the exemplary embodiment to first and second user groups 1200A and 1200B. Alternatively the first and second user groups 1200A and 1200B may be geographically disparate and access the network 100 through multiple APs, not shown for clarity, distributed geographically by the network operator or operators. First cellular AP 1295A as show provides coverage to first user group 1200A and environment 1270, which comprises second user group 1200B as well as first user group 1200A. Accordingly, the first and second user groups 1200A and 1200B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 1200A may form associations either through standards such as IEEE 802.15 and Bluetooth as well in an ad-hoc manner.

Also connected to the network 100 are Social Networks (SOCNETS) 1265, first and second Attribute Providers 1270A and 1270B respectively, e.g. Entrust™ and ACI Worldwide™, first and second government photographic identity providers 1275A and 1275B respectively, e.g. California Department of Motor Vehicles and US Department of State, and first and second Authentication Services 1275C and 1275D respectively, e.g. Verisign™ and Assure 360™, as well as first and second servers 1290A and 1290B which together with others, not shown for clarity. First and second servers 1290A and 1290B may host according to embodiments of the inventions multiple services associated with a provider of publishing systems and publishing applications/platforms (RVWIEs); a provider of a SOCNET or Social Media (SOME) exploiting RVWIE features; a provider of a SOCNET and/or SOME not exploiting RVWIE features; a provider of services to PEDS and/or FEDS; a provider of one or more aspects of wired and/or wireless communications; an Enterprise 1260 exploiting RVWIE features; license databases; content databases; image databases; content libraries; customer databases; websites; and software applications for download to or access by FEDs and/or PEDs exploiting and/or hosting RVWIE features. First and second primary content servers 1290A and 1290B may also host for example other Internet services such as a search engine, financial services, third party applications and other Internet based services.

Accordingly, a user may exploit a PED and/or FED within an Enterprise 1260, for example, and access one of the first or second servers 1290A and 1290B respectively to perform an operation such as accessing/downloading an application which provides RVWIE features according to embodiments of the invention; execute an application already installed providing RVWIE features; execute a web based application providing RVWIE features; or access content. Similarly, a user may undertake such actions or others exploiting embodiments of the invention exploiting a PED or FED within first and second user groups 1200A and 1200B respectively via one of first and second cellular APs 1295A and 1295B respectively and first Wi-Fi nodes 1210A.

As noted supra first and second servers 1290A and 1290B together with others may host a variety of software systems and/or software applications supporting embodiments of the invention. However, embodiments of the invention may not only operate locally, regionally, or nationally but internationally and globally. Accordingly, some servers may manage and control operations in execution upon other servers. For example, an Authentication Service such as Authentication Service 190 in FIG. 1 (e.g. Assure360) may operate a server or servers within one or more jurisdictions which authenticate, using one or more machine authentications techniques servers, within that jurisdiction as well as other jurisdictions. Each jurisdiction server may be operated by the same Authentication Service as manages the supervisory servers or it may be operated by one or more Identity Authority Servers authorised by the Authentication Service managing the supervisory servers. Optionally, such providers of Authentication Services may be regulated by government regulatory bodies within their respective jurisdictions. As noted supra as the verification processes are performed on firewalled servers associated with the physical attribute provider (PHYSAPs) then data relating to true original government issued photographic identity documents is maintained secure and private whilst the only information transmitted from a store front relying party is the extracted data for the presented government issued photographic identity document and that transmitted from a PHYSAP is the result of the verification/validation process. Similarly, data transmitted from an Attribute Provider is restricted, e.g. only the Identity Verification Score (IdVS) provided from the Attribute Provider server, e.g. Ping 360 server, to the card reader at the store front relying party, e.g. Store Front Relying Party (TL1) 170A.

Accordingly, where government issued photographic identity cards are standardized, e.g. driver′ licenses in all member states of the European Community, then the processes relating to the store front relying parties may be similarly tracked and employed across multiple jurisdictions. Alternatively, the user may transact business within another jurisdiction based upon the validation and verification of their identity. In such instances where a jurisdiction server (e.g. a country server) is transacting on behalf of a user (e.g. doing business or presenting their government issued photographic identity card) in another jurisdiction (e.g. country) then the two jurisdiction servers will first identify themselves before the user's digital identity will be assured by the jurisdiction server in the jurisdiction they live. Due to different provincial, state, territorial, differences such jurisdictions may include different states, regions, territories, etc., for example.

It would be evident that authentication may be conducted by an online relying party in the country in which the user is conducting business or by the user's Identity Provider (if the user uses one), if the online relying party the user is transaction with is networked with the user's Identity Provider. It would be evident that some enterprises and/or organizations acting as online relying parties, e.g. Google, American Express, HSBC and Facebook, may act as global identity providers whereas other online relying parties, e.g. Verizon and Chase Manhattan, may be only US identity providers.

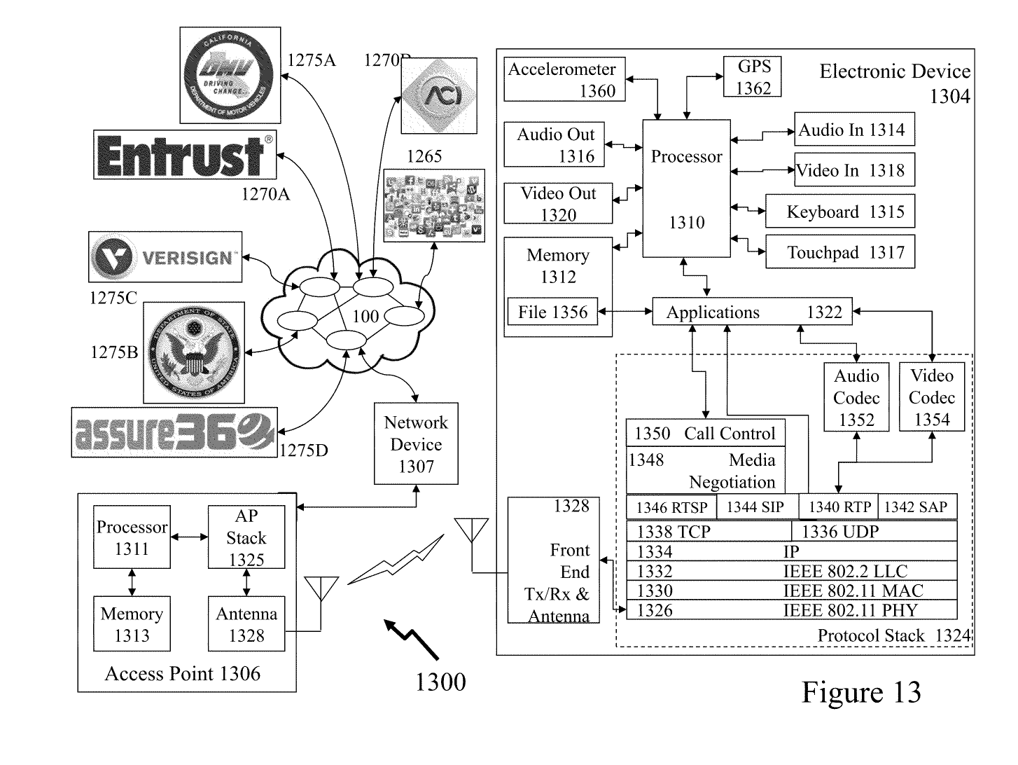

Now referring to FIG. 13 there is depicted an electronic device 1304 and network access point 1307 supporting RVWIE features according to embodiments of the invention. Electronic device 1304 may, for example, be a PED and/or FED and may include additional elements above and beyond those described and depicted. Also depicted within the electronic device 1304 is the protocol architecture as part of a simplified functional diagram of a system 1300 that includes an electronic device 1304, such as a smartphone 1255, an access point (AP) 1306, such as first AP 1210, and one or more network devices 1307, such as communication servers, streaming media servers, and routers for example such as first and second servers 1290A and 1290B respectively. Network devices 1307 may be coupled to AP 1306 via any combination of networks, wired, wireless and/or optical communication links such as discussed above in respect of FIG. 12 as well as directly as indicated. Network devices 1307 are coupled to network 100 and therein Social Networks (SOCNETS) 1265, first and second Attribute Providers 1270A and 1270B respectively, e.g. Entrust™ and ACI Worldwide™, first and second government photographic identity providers 1275A and 1275B respectively, e.g. California Department of Motor Vehicles and US Department of State, and first and second Authentication Services 1275C and 1275D respectively, e.g. Verisign™ and Assure 360™.

The electronic device 1304 includes one or more processors 1310 and a memory 1312 coupled to processor(s) 1310. AP 1306 also includes one or more processors 1311 and a memory 1313 coupled to processor(s) 1310. A non-exhaustive list of examples for any of processors 1310 and 1311 includes a central processing unit (CPU), a digital signal processor (DSP), a reduced instruction set computer (RISC), a complex instruction set computer (CISC) and the like. Furthermore, any of processors 1310 and 1311 may be part of application specific integrated circuits (ASICs) or may be a part of application specific standard products (ASSPs). A non-exhaustive list of examples for memories 1312 and 1313 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 1304 may include an audio input element 1314, for example a microphone, and an audio output element 1316, for example, a speaker, coupled to any of processors 1310. Electronic device 1304 may include a video input element 1318, for example, a video camera or camera, and a video output element 1320, for example an LCD display, coupled to any of processors 1310. Electronic device 1304 also includes a keyboard 1315 and touchpad 1317 which may for example be a physical keyboard and touchpad allowing the user to enter content or select functions within one of more applications 1322. Alternatively the keyboard 1315 and touchpad 1317 may be predetermined regions of a touch sensitive element forming part of the display within the electronic device 1304. The one or more applications 1322 that are typically stored in memory 1312 and are executable by any combination of processors 1310. Electronic device 1304 also includes accelerometer 1360 providing three-dimensional motion input to the process 1310 and GPS 1362 which provides geographical location information to processor 1310.

Electronic device 1304 includes a protocol stack 1324 and AP 1306 includes a communication stack 1325. Within system 1300 protocol stack 1324 is shown as IEEE 802.11 protocol stack but alternatively may exploit other protocol stacks such as an Internet Engineering Task Force (IETF) multimedia protocol stack for example. Likewise AP stack 1325 exploits a protocol stack but is not expanded for clarity. Elements of protocol stack 1324 and AP stack 1325 may be implemented in any combination of software, firmware and/or hardware. Protocol stack 1324 includes an IEEE 802.11-compatible PHY module 1326 that is coupled to one or more Front-End Tx/Rx & Antenna 1328, an IEEE 802.11-compatible MAC module 1330 coupled to an IEEE 802.2-compatible LLC module 1332. Protocol stack 1324 includes a network layer IP module 1334, a transport layer User Datagram Protocol (UDP) module 1336 and a transport layer Transmission Control Protocol (TCP) module 1338.

Protocol stack 1324 also includes a session layer Real Time Transport Protocol (RTP) module 1340, a Session Announcement Protocol (SAP) module 1342, a Session Initiation Protocol (SIP) module 1344 and a Real Time Streaming Protocol (RTSP) module 1346. Protocol stack 1324 includes a presentation layer media negotiation module 1348, a call control module 1350, one or more audio codecs 1352 and one or more video codecs 1354. Applications 1322 may be able to create maintain and/or terminate communication sessions with any of devices 1307 by way of AP 1306. Typically, applications 1322 may activate any of the SAP, SIP, RTSP, media negotiation and call control modules for that purpose. Typically, information may propagate from the SAP, SIP, RTSP, media negotiation and call control modules to PHY module 1326 through TCP module 1338, IP module 1334, LLC module 1332 and MAC module 1330.

It would be apparent to one skilled in the art that elements of the electronic device 1304 may also be implemented within the AP 1306 including but not limited to one or more elements of the protocol stack 1324, including for example an IEEE 802.11-compatible PHY module, an IEEE 802.11-compatible MAC module, and an IEEE 802.2-compatible LLC module 1332. The AP 1306 may additionally include a network layer IP module, a transport layer User Datagram Protocol (UDP) module and a transport layer Transmission Control Protocol (TCP) module as well as a session layer Real Time Transport Protocol (RTP) module, a Session Announcement

Protocol (SAP) module, a Session Initiation Protocol (SIP) module and a Real Time Streaming Protocol (RTSP) module, media negotiation module, and a call control module. Portable and fixed electronic devices represented by electronic device 1304 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

Within embodiments of the invention described supra in respect of photographic identity issuers then the attributes relating to the photographic identity issuer data may be stored on their own servers, i.e. Identity Authority Server(s).

Within embodiments of the invention described supra the identity attribute matching engine may form part of the identity issuer's servers and/or systems or alternatively it may be part of the Identity Authority Server.

Within the embodiments of the invention described supra hashing relates to the application of a cryptographic hash function using the one-time key described as being provided. However, it would be evident that other encryption techniques may be employed to securely store data for subsequent use in verification of subsequently presented data. Further, the transmission of content between the different elements within the overall system and systems depicted and described may be subject to further encryption such that the hashed data is itself encrypted further for transmission, for example.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of user verification comprising:
providing from a user system to a server personal data of a first user;
providing from the server to an authority server the personal data of the first user, the personal data for being verified;
verifying the personal data of the first user against data stored by the authority server to provide a verification signal indicative of whether the personal data is verified as accurate or other than accurate, the authority server other than a commercial party to a commercial transaction between the first user and the server; and
when the personal data of the first user corresponds with data stored by the authority server, providing the verification signal indicating that the personal data is accurate personal data of the first user to the server.

2. A method according to claim 1, wherein the authority server is absent the personal data of the first user stored therein, the authority server for verifying the personal data based on data derived from the personal data from which the personal data is other than derivable.

3. A method according to claim 2, comprising:
hashing the personal data to provide hashed personal data;
providing the hashed personal data to the authority server;
comparing the hashed personal data to stored hashed personal data stored within the authority server to determine a correspondence therebetween; and
in dependence upon a correspondence between the hashed personal data and the hashed personal data stored within the authority server providing an authorization signal to the server.

4. A method according to claim 2, comprising:
providing from the authority server a value for use in hashing of data;
hashing the personal data based on the value to provide hashed personal data;
providing the hashed personal data to the authority server;
comparing the hashed personal data to stored hashed personal data stored within the authority server to determine a correspondence therebetween; and
in dependence upon a correspondence between the hashed personal data and the hashed personal data stored within the authority server providing an authorization signal to the server.

5. A method according to claim 4, wherein the value is provided to the server and wherein hashing is performed by the server.

6. A method according to claim 4, wherein the personal data is stored within a secure personal data store and the value is provided to the secure personal data store and wherein hashing is performed by the secure personal data store.

7. A method according to claim 1, wherein the authority server is at least one:
absent the personal data of the first user accessible thereto, the authority server for verifying the personal data based on data derived from the personal data from which the personal data is other than derivable; and
comprises the personal data of the first user stored therein, the authority server for verifying the personal data against the stored personal data of the first user.

8. A method comprising:
initiating a session between a first user system and a server;
communicating personal data from a secure personal data store of the first user system to the server;
communicating from the server to an authority server a request for verification of the personal data;
verifying by the authority server the personal data;
when the personal data is other than accurate, providing a first signal indicative of the first data being other than accurate; and
when the personal data is accurate, providing a first signal indicative of the first data being authorized.

9. A method according to claim 8, comprising:
determining for a piece of personal data a verification server to verify the piece of personal data; and
communicating from the authority server to the verification server data for use in verifying the piece of personal data,
wherein verifying by the authority server is performed in dependence upon a reply signal from the verification server.

10. A method according to claim 9, wherein the authority server is absent the personal data of the first user stored therein, the authority server for verifying the personal data based on data derived from the personal data from which the personal data is other than derivable.

11. A method according to claim 10, comprising:
hashing the personal data to provide hashed personal data;
providing the hashed personal data to the authority server;
comparing the hashed personal data to stored hashed personal data stored within the authority server to determine a correspondence therebetween; and
in dependence upon a correspondence between the hashed personal data and the hashed personal data stored within the authority server providing an authorization signal to the server.

12. A method according to claim 10, comprising:
hashing the personal data to provide hashed personal data;
providing the hashed personal data to the authority server;
comparing the hashed personal data to stored hashed personal data stored within the authority server to determine a correspondence therebetween; and
in dependence upon a correspondence between the hashed personal data and the hashed personal data stored within the authority server providing an authorization signal to the server.

13. A method according to claim 10, comprising:
providing from the authority server a value for use in hashing of data;
hashing the personal data based on the value to provide hashed personal data;
providing the hashed personal data to the authority server;
comparing the hashed personal data to stored hashed personal data stored within the authority server to determine a correspondence therebetween; and
in dependence upon a correspondence between the hashed personal data and the hashed personal data stored within the authority server providing an authorization signal to the server.

14. A method according to claim 13, wherein at least one of:
the value is provided to the server and wherein hashing is performed by the server; and
the personal data is stored within a secure personal data store and the value is provided to the secure personal data store and wherein hashing is performed by the secure personal data store.

15. A method according to claim 1, wherein
the personal data relates to an image of the first user within an identity document;
the authority server is associated with the issuer of the identity document.

16. A method according to claim 8, wherein the authority server is absent the personal data of the first user accessible thereto, the authority server for verifying the personal data based on data derived from the personal data from which the personal data is other than derivable.

17. A method according to claim 8, wherein the authority server comprises the personal data of the first user stored therein, the authority server for verifying the personal data against the stored personal data of the first user.

18. A method comprising:
providing an authority server for verifying personal data of each of a plurality of users;
providing verification data to the authority server for use in verification, the verification data other than the personal data and provided with an indication of a security of the provided data; and
storing within a database the verification data and the data associated with a security of the data for use in authenticating personal data of each of the plurality of users.

19. A method comprising:
storing personal data within a secure personal data store of a first user system;
establishing a secure connection with a server, the secure connection between the server and the first user system;
transmitting from the first user system to the server, personal data from the secure personal data store of the first user system;
verifying the personal data received at the server by:
transmitting a request for personal data verification to an authority server; and
receiving from the authority server a verification signal indicative of the data being verified when data relating to the personal data matches expected values within the authority server, the authority server other than a commercial party forming part of commerce relating to the transaction.

20. A method according to claim 19, wherein the personal data comprises at least one of a passport number, a set of personal data; and a correlation between user identifying data and commercial data of the user.
